(19) United States
(12) Patent Application Publication
(10) Pub. No.: US 2009/0319397 A1
(43) Pub. Date: Dec. 24, 2009

(54) VIRTUAL EXPERIENCE

(75) Inventors: Steven H. Joe, Coto de Caza, CA (US); Daniel S. Kelley, Aliso Viejo, CA (US)

Correspondence Address: BERKELEY LAW & TECHNOLOGY GROUP, LLP, 17933 NW Evergreen Parkway, Suite 250, BEAVERTON, OR, 97006, US

(73) Assignee: D-LINK SYSTEMS, INC., Fountain Valley, CA (US)

(21) Appl. No.: 12/142,731

(22) Filed: Jun. 19, 2008

(51) Int. Cl. G06F 3/048; G06Q 30/00

(52) U.S. Cl. 705/27; 715/716

(57) ABSTRACT

The subject matter disclosed herein relates to systems and methods for providing an interactive experience.

### BACKGROUND

1. Field

The subject matter disclosed herein relates to systems and methods for providing an interactive virtual shopping and visitor service experience.

2. Information

Buying items through electronic commerce via the Internet has achieved widespread popularity. Items can typically be purchased over the Internet with considerably less effort than purchasing them using conventional means. Electronic commerce, though, is far from ideal where the shopper is left to their own skills in navigating an oftentimes less than intuitive website through a series of static icons. Further, and especially for the technical products buyer, the online shopper is left to figure out on their own what products are available with the desired features, the compatibility between products, and assembly and integration within new or existing installations.

The online shopper does not have an advantage found at a retail store, that is, the interaction with a knowledgeable sales and support person.

### BRIEF DESCRIPTION OF THE FIGURES

Non-limiting and non-exhaustive embodiments will be described with reference to the following figures, wherein like reference numerals refer to like parts throughout the various figures unless otherwise specified.

FIG. 1 is a schematic diagram of the various experiences of the virtual shopping experience, in accordance with an embodiment;

FIG. 2 is a graphic illustration of an Entry Page of the virtual experience, in accordance with an embodiment;

FIG. 3 is a graphic illustration of a networked system in accordance with an embodiment;

FIG. 4 is a schematic diagram of the virtual environment content server, in accordance with an embodiment;

FIG. 5 is a flow diagram of a method of providing a web-based interactive virtual environment in accordance with an embodiment;

FIG. 6 is a schematic diagram of the virtual host control, in accordance with an embodiment; and

FIG. 7 is a schematic diagram of the virtual host control, in accordance with another embodiment;

FIG. 8 is a graphic illustration of a Shopping Page of the virtual experience, in accordance with an embodiment; and

FIG. 9 is a graphic illustration of a Tech Support Page of the virtual experience, in accordance with an embodiment.

### DETAILED DESCRIPTION

Hereinafter, the term “Web browser” refers to any software program which can display text, graphics, or both, from Web pages on World Wide Web sites. Hereinafter, the term “Web page” refers to any document written in a mark-up language including, but not limited to, HTML (hypertext make-up language) or VRML (virtual reality modeling language), dynamic HTML, XML (extended mark-up language) or related computer languages thereof, as well as to any collection of such documents reachable through one specific Internet address or at one specific World Wide Web site, or any document obtainable through a particular URL (Universal Resource Locator). Hereinafter, the term “Web site” refers to at least one Web page, and preferably a plurality of Web pages, virtually connected to form a coherent group.

Hereinafter, the term “network” refers to a connection between any two computers and/or devices which permit the transmission of data. Hereinafter, the term “computer” includes, but is not limited to, cell phones, personal digital assistants (PDA), personal computers (PC) having an operating system such as DOS, Windows™, OS/2™ or Linux; Macintosh™ computers; computers having JAVA™-OS as the operating system; and graphical workstations such as the computers of Sun Microsystems™ and Silicon Graphics™, and other computers having some version of the UNIX operating system such as AIX™ or SOLARIS™ of Sun Microsystems™; or any other known and available operating system. Hereinafter, the term “Windows™” includes but is not limited to Windows95™, Windows 3.x™ in which “x” is an integer such as “1” , Windows NT™, Windows98™, Windows CE™, Windows VISTA™ and any upgraded versions of these operating systems by Microsoft Inc. (Seattle, Wash., USA).

Hereinafter, the phrase “display a Web page” includes actions to enable rendering of at least a portion of the information on a Web page available to a visitor. As such, this phrase includes, but is not limited to, static visual display of static graphical information, audible production of audio information, animated visual display of animation and the visual display of video stream data.

Hereinafter, the term “video” includes video media data, and combination of video and audio media data.

Hereinafter, the term “visitor” refers to the person who operates a Web browser and/or other GUI interface to navigate through a website.

References are made herein to “servers” capable of providing resources over a data communication network. Such resources may comprise, for example, stored information and/or computational resources. Accordingly, a server may comprise one or more computing platforms comprising, for example, one or more processors coupled to a storage medium or memory by a data bus. In a particular example, such a computing platform may be adapted to execute machine-readable instructions stored in a memory for executing procedures to implement claimed subject matter. Likewise, client terminals identified herein may comprise computing platforms adapted to implement one or more aspects of claimed subject matter.

In particular embodiments illustrated herein, an online portal is provided to guide visitors through a shopping experience in a virtual world guided by a virtual host providing sales and support services. Such a guided tour may give the visitor information enabling the visitor to make a buying decision or gain support for an existing product purchase, for example.

In the following embodiments, any references made to “technology products and support” is by way of example and not limited thereto. It is understood that the embodiments referenced herein may be implemented for other product marketing, sales and support, and not limited to those described. For example, a visitor looking to purchase and install technology products, such as wireless computer networks, can be easily overwhelmed by the vast array of highly technical products that require a certain level of knowledge and skill in order to make the purchasing decision and subsequent implementation.

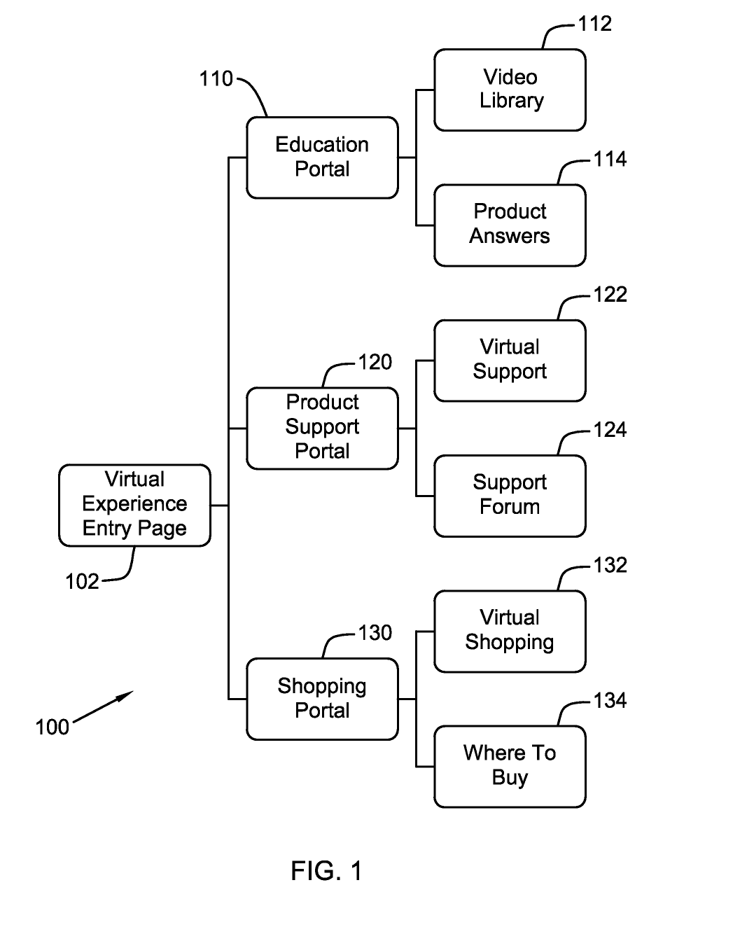

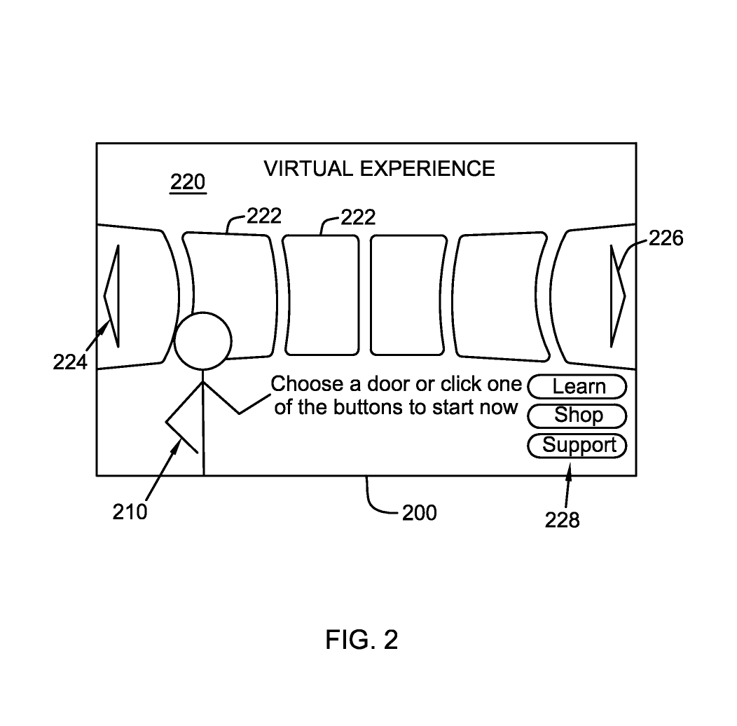

FIG. 1 is a schematic diagram illustrating various aspects of virtual experience 100, in accordance with an embodiment. FIG. 2 is a graphic illustration of entry page 200 of such a virtual experience, in accordance with a particular implementation. Here, a visitor may be welcomed to a website by virtual host 210 on entry page 200. Virtual host 210 may be provided as a live-action video overlaid upon virtual environment background 220. The live-action video may be produced by filming a live actor presenting a scripted performance, for example. Virtual host 210 may guide a visitor through portals of virtual experience 100 providing guidance, suggestions and information.

Referring again to FIG. 1, in particular embodiments, various experiences of virtual experience 100 may include education portal 110, shopping portal 130, and product support portal 120. Education portal 110 may provide a visitor access to video library 112, including of video presentations on subject matter, such as, but not limited to, products, interviews with technology editors and analysts, and discussions about solutions for merchant products and complementary technologies, just to name a few examples. Education portal 110 may also provide a visitor with product answers 114 in the form of media other than video. Virtual host 210 may introduce and/or participate in the presentation of the information.

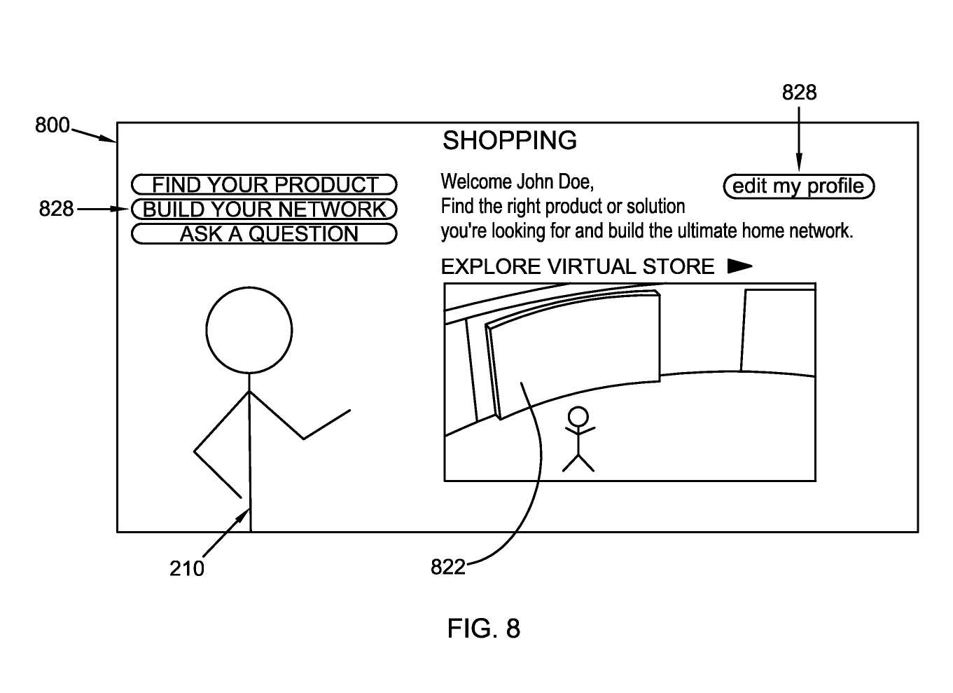

Shopping portal 130 may include virtual shopping portal 132 and “where to buy” portal 134, for the shopping and purchasing experience, respectively. FIG. 8 is a graphic illustration of shopping page 800 of such a virtual experience, in accordance with a particular implementation. Here, a visitor may be welcomed to shopping page 800 by virtual host 210. Doors 822 are selectable to enter other portals. Alternatively, the visitor may choose one of button icons 828 through which the visitor may enter one of a plurality of other portals. Product resources found in other portals of virtual experience 100 may be made available to a prospective buyer to assist in the shopping process. Where virtual experience 100 may be provided by an e-tailer, for example, the visitor may be directed to their virtual shopping portal 132. Where virtual experience 100 may be provided by an equipment manufacture, shopping portal 130 may point the visitor to “where to buy” 134 for retail and e-tail shopping sites for further shopping and eventual purchase. Virtual host 210 may introduce and/or participate in the presentation of the shopping information.

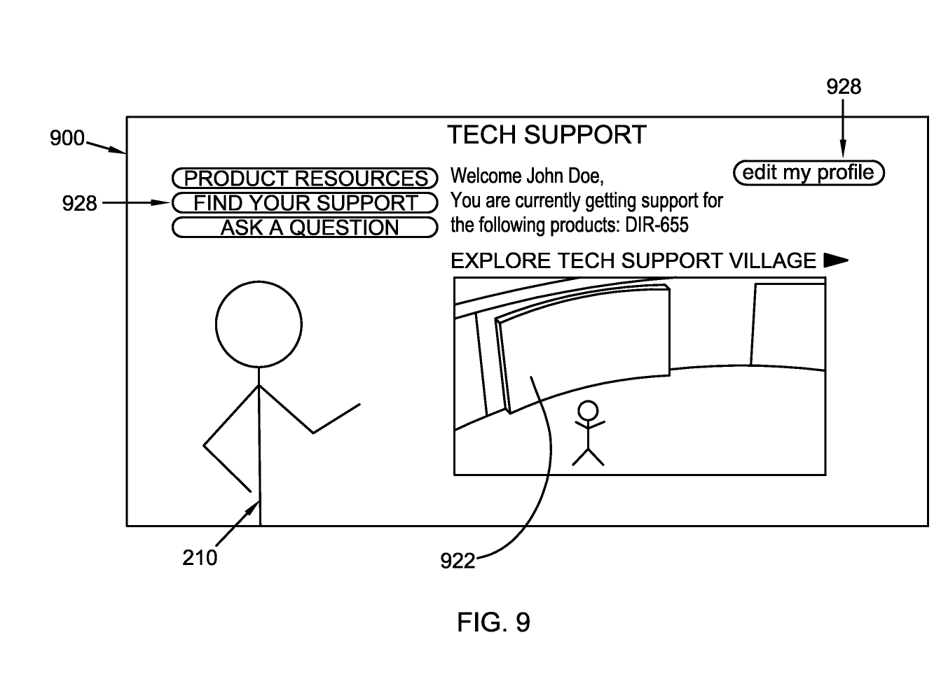

Product support portal 120, also herein referred to as Tech Support, may provide, such as, but not limited to, virtual support portal 122 and support forum 124. Virtual support portal 122 may provide visitors an opportunity to virtually interact with virtual host 210 for technical support to answer product questions and gain help on technical issues. FIG. 9 is a graphic illustration of Tech Support page 900 of such a virtual experience, in accordance with a particular implementation. Here, a visitor may be welcomed to tech support page 900 by virtual host 210. Doors 922 are selectable to enter other portals. Alternatively, the visitor may choose one of button icons 928 through which the visitor may enter one of a plurality of other portals. Support forum 124 may provide a visitor with an opportunity to join into a bulletin board-type forum for asking questions or posting knowledge for other visitor questions. Experts may be provided to manage support forum 120 and provide information in the form of posts for visitors.

Referring again to FIG. 2, virtual experience 220 may provide an immersive 3D graphical environment to a visitor. In the embodiment of FIG. 2, virtual host 210 may invite the visitor to enter one of a plurality of doors 222 through which the visitor may enter one of the plurality of portals, such as education portal 110, shopping portal 130, and product support portal 120 as shown in FIG. 1. Doors 222 may be made to appear horizontally revolving in background 220 behind virtual host 210 presenting each door 222 to the visitor. A visitor may select a particular door 222 by mouse click to be presented with a chosen portal. Left scroll button 224 and right scroll button 226 are also provided for moving doors 222 either left or right, respectively. Alternatively, the visitor may choose one of button icons 228 through which the visitor may enter one of the plurality of portals, such as education portal 110, shopping portal 130, and product support portal 120.

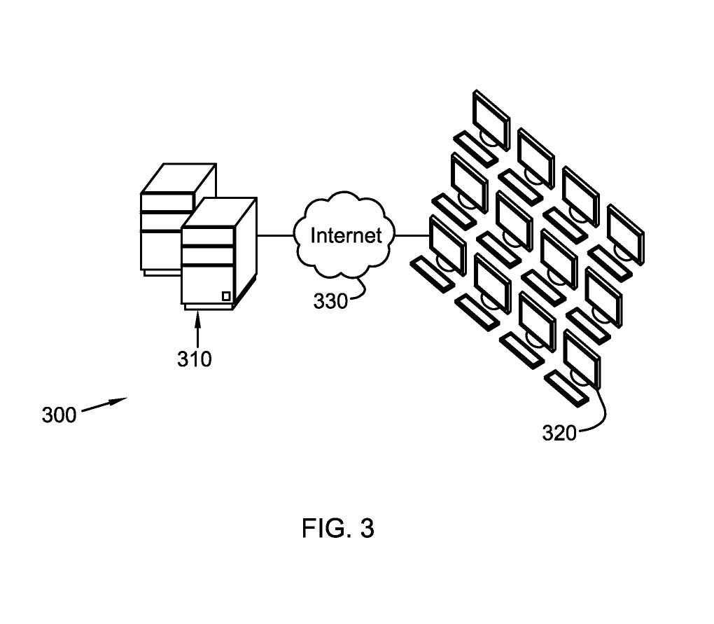

FIG. 3 is a graphic illustration of networked system 300 in accordance with an embodiment. Virtual experience 100 may be hosted on virtual environment content server 310 that may be in communication with visitor's client device 320 via internet 330. It is understood that other modes of communication between virtual environment content server 310 and client device 320 are anticipated. As will be explained below, client device 320 may be a device, such as, but not limited to, a personal computer, a cell phone, a PDA, a notebook computer, and a home entertainment appliance, and any other device suitable for the particular purpose.

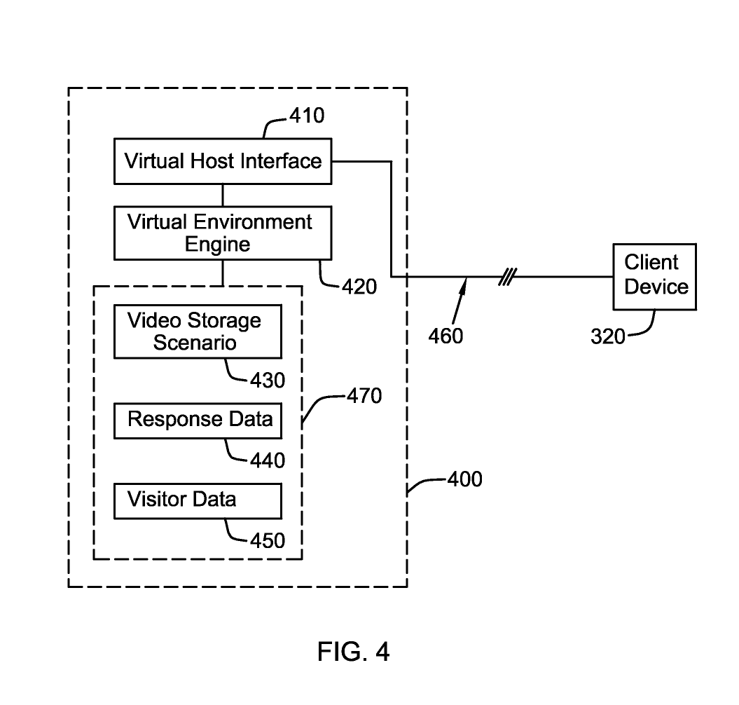

FIG. 4 is a schematic diagram of virtual environment content server 400 in communication with client device 320, in accordance with an embodiment. Virtual environment content server 400 comprises virtual host interface 410, virtual environment engine 420, and server computer readable storage 470. Client device 320 may be coupled to network 460 operable to enable a visitor to communicate with virtual environment content server 400 via virtual host interface 410. Virtual environment engine 420 may be operable to present an interactive scene on a display of client device 320 in the form of background 220, with virtual host interface 410 overlaying virtual host 210 thereon, as shown in FIG. 2.

Virtual host interface 410 may be in communication with a plurality of video files 430 stored on server computer readable storage 470. Each video file may comprise an audio and video recording of a human actor presenting a scripted performance. The scripted performance comprises compositions, such as, but not limited to, instructions, marketing, sales, and support topics.

Virtual host interface 410 may be also in communication with response data 440 and visitor data 450 stored on the server computer readable storage 470. Response data 440 may contain a plurality of possible visitor responses. Visitor data 450 may be data provided by the visitor such as user preferences and an inventory of previously purchased products.

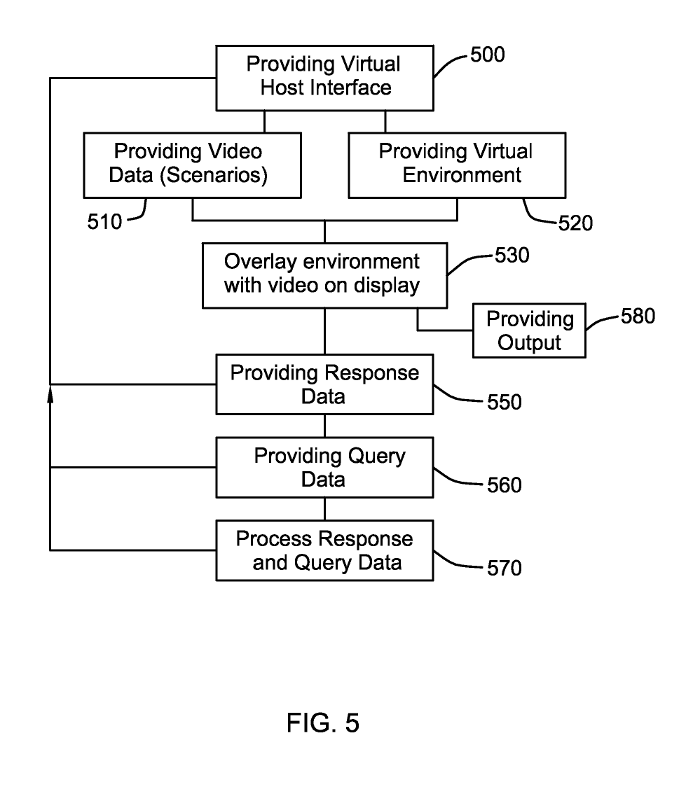

FIG. 5 is a flow diagram illustrating a process of providing a web-based interactive virtual environment in accordance with an embodiment. This process comprises providing virtual host interface 500 suitable for controlling the operation of the interactive virtual environment in response to visitor input. The process further comprises providing video data 510 representing a plurality of scenarios and providing a plurality of computer generated virtual environments 520, with the scenario overlaid on predetermined virtual environment 530. The process further comprises providing response data 550 representing possible visitor responses, and providing query data 560 representing query information suitable to persuade the visitor to select an object in the virtual environment. The process further comprises processing response data and query data 570 so as to provide predetermined video data and provide the video data in a predetermined virtual environment that the visitor may be interested, and providing output 580 suitable for displaying the predetermined video data in the predetermined virtual environment to the visitor.

In an embodiment, providing video data 510 representing a plurality of scenarios comprises providing a plurality of video files, each video file providing a a video representation of a human virtual host providing a predetermined scripted presentation. Providing a plurality of computer generated virtual environments 520 comprises providing visitor-selectable responses and generating response data based on the visitor-selectable response.

In an embodiment, providing video data 510 comprises providing video files that are a video representation of a human virtual host providing a predetermined scripted presentation, each scripted presentation providing one or more of information related to product education, technical support, and sales.

Referring again to FIG. 2, in accordance with an embodiment, providing a plurality of computer generated virtual environments 520 comprises providing visitor-selectable iconic doors 222 that horizontally rotate in background 220 behind virtual host 210. A particular door 222 may be operable so as when selected, causes the view to move through door 222 into another predetermined interactive virtual environment with another predetermined video representation related to a visitor's desired response.

Referring again to FIGS. 1 and 5, in accordance with an embodiment, the process further comprises wherein providing video data 510 comprises providing a plurality of video files that are visitor-selectable based on the visitor response. A video files may contain media data with subject matter related to education portal 112, shopping portal 130, and product support portal 120. Education portal 110 may provide an associated video library 112 that may contain media such as subject matter comprising one or more of product information, interviews with technology editors, analysis and discussions about technology trends and solutions, product installation, and product sales.

Shopping portal 130 may present virtual host 210 as a virtual salesperson in a virtual store for the presentation of product and product related information, and wherein the associated video files may contain media with one or more subject matter related to product sales.

Product support portal 120 may present virtual host 210 as a virtual technical support representative and wherein the associated video files may contain media with one or more subject matter related to product technical support.

In accordance with an embodiment, virtual shopping experience 100 may provide for assisting a visitor in the selection, purchasing, and use of a product from a merchant website. Virtual shopping experience 100 may offer a plurality of available products in at least one product category. As shown in FIGS. 3 and 4, virtual shopping experience 100 may comprise virtual environment content server 310 comprising virtual host interface 410, virtual environment engine 420, and media storage 430 including a plurality of scenarios. The scenarios may include a set of learning scenarios, a set of shopping scenarios, and a set of product support scenarios.

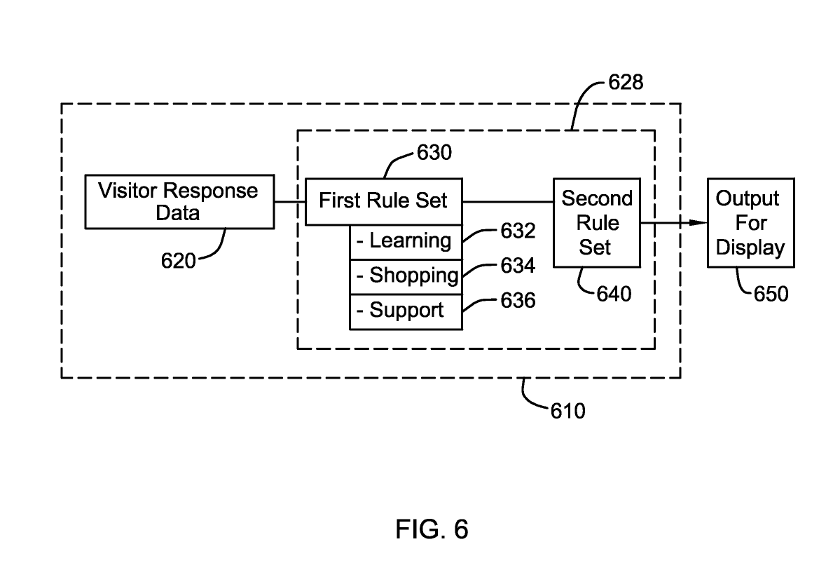

Virtual host interface 410 further comprises a virtual host control. FIG. 6 is a schematic diagram of virtual host control 610, in accordance with an embodiment. Virtual host control 610 comprises visitor response data 620 and rules engine 628 including first rule set 630 and second rule set 640. Virtual host control 610 may be operative to provide output 650 suitable for display, such as on a client display, the content of output 650 including a video representation of a human virtual host overlaid on an interactive scene provided by the virtual environment engine. Virtual host interface 610 may be operable to compare a response of a visitor to at least one predetermined response corresponding to at least one video file in accordance with first rule set 630. If the response matches a predetermined response, virtual host interface 610 may be configured to responsively provide output 650 suitable to display the video file on a client display in accordance with second rule set 640. Virtual host interface 610 may be configured to use one of the video files based on a response of the visitor so as to simulate live interaction between the visitor and the virtual host.

First rule set 630 may govern whether the visitor may be interested in either of the learning scenarios 632, shopping scenarios 634, or product support scenarios 636, and, which one or more of either of the learning scenarios, shopping scenarios, and product support scenarios may be provided as output 650 to the visitor. First rule 630 set may contain logical operators.

Second rule set 640 may govern the respective order of output 650 of the one or more of either of the learning scenarios, shopping scenarios, and product support scenarios. Second rule set 640 may contain logical operators.

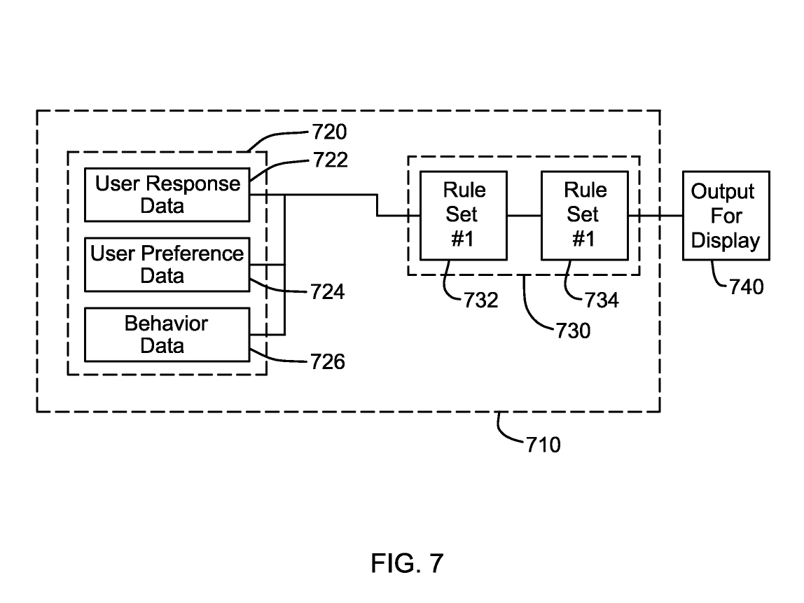

FIG. 7 is a schematic diagram of virtual host control 710, in accordance with another embodiment. Virtual host control 710 comprises visitor data 620 and rules engine 628. User data 720 comprises user response data 722, user preference data 724, and behavior data 726. Rules engine 730 comprises first rule set 732 and second rule set 734.

Virtual host control 710 may be operable to compare a response of the visitor to at least one predetermined response corresponding to at least one video file in accordance to first rule set 732. If the response matches a predetermined response, virtual host control 710 may be operable to responsively provide output 740 suitable for the display the video file on, such as, a client display in accordance to second rule set 734.

Virtual host interface 610 may be operable to record preference data 724, a response of the visitor as response data 722, and to process response trend data as behavior data 726, further discussed below, which may be stored in server computer readable storage. Referring again to FIG. 4, virtual environment content server 400 may be operable to process preference data 724, response data 722, and behavior data 726, in virtual environment engine 420, so as to generate output suitable for displaying a corresponding virtual environment 520 and corresponding video file to a visitor.

In accordance with embodiments, including those of FIGS. 6 and 7, virtual host interface 410 may utilize virtual host control 610, 710 to manage a plurality of video files representing the plurality of scenarios as output 650, 740 suitable for presenting to a visitor. The scenarios may relate to the available products and the interests of the visitor. The scenarios may be associated with one or more of a plurality of response possibilities from the visitor based on first rule set 630, 732 and second rule set 640, 734, in rules engine 628, 730, respectively. The scenarios may have a changeable order based, at least in part, on the visitor response and preferences.

First rule set 630, 732 may govern whether one of the learning scenarios, shopping scenarios, and product support scenarios, may be presented to a visitor, and, if so, which of the learning scenarios, shopping scenarios, and product support scenarios is presented to the visitor. First rule set 630, 732 may contain logical operators.

Second rule set 640, 734 may govern the respective order of presentation of the learning scenarios, shopping scenarios, and product support scenarios. Second rule set 640, 734 may contain logical operators.

Virtual host interface 410 may automatically generate and organize the learning scenarios, shopping scenarios, and product support scenarios governed by first rule set 630, 732 and second rule set 640, 734 in response to click-through interaction with a website hosting a virtual environment content server 310.

In an embodiment, virtual host interface 410 may receive behavioral data 726 about a visitor. Virtual host interface 410 may determine whether behavioral data 726 is sufficient to prove at least one rule of first rule set 630, 732 and second rule set 640, 734.

Virtual host interface 410 may be operative to apply first rule set 630, 732 to determine the respective group of scenarios from the plurality of available groups representative of the learning scenarios, the shopping scenarios, and the product support scenarios, and may be operative to applying second rule set 640, 734 to determine the respective order of presentation of the learning scenarios, shopping scenarios, and product support scenarios. Virtual host interface 410 may be operative to process first rule set 630, 732 according to logical operators, and process second rule set 640, 734 according to logical operators. Virtual host interface 410 may be operative to receive responses from a visitor and determine whether the responses from the visitor are sufficient to prove a rule of first rule set 630, 732.

Virtual host interface 410 may be operative to select one of the learning scenarios, the shopping scenarios, and the product support scenarios to present to a visitor. Virtual host interface 410 may be operative to select a closest rule from first rule set 630, 732 and determine if the closest rule can be proven by responses from the visitor, and if so, present the visitor with a scenario associated with the closest rule, and if not, exempt the closest rule from first rule set 630, 732 and determine if a next closest rule can be selected from first rule set 630, 732. Virtual host interface 410 may be operative to select a closest rule from second rule set 640, 734 and determine if the closest rule can be proven by responses from the visitor, and if so, present the visitor with a scenario associated with the closest rule, and if not, exempt the closest rule from second rule set 640, 734 and determine if a next closest rule can be selected from second rule set 640, 734.

According to an embodiment, the virtual environment experience that is provided to a visitor in a shopping area may be altered and/or adjusted in response to feedback information. In one embodiment, such a virtual environment experience for a visitor may be altered and/or tailored according to specific preferences and behaviors of a particular visitor.

A subsequent scenario may be selected based in part on the visitor's response. For example, the subsequent scenario may be selected as a first scenario based on direct visitor response made and a second or subsequent scenario based on artificial intelligence selecting the most appropriate scenario anticipated for the visitor. Alternatively, or in addition, the visitor's response may indicate a visitor's choice and the subsequent scenario is determined in part by that choice.

A scenario may be represented by any number of variables that are relevant to a particular virtual environment. For example, the scenario may include a measure of the technical level of the visitor, areas surfed by the visitor, and choices after viewing a particular scenario.

The selection of the scenario may be affected by a visitor's behavior as the visitor interacts with a virtual environment. A scenario may also be characterized by particular actions that are enabled at that particular scenario, as well as information that is presented to the visitor in that scenario. In one embodiment, a particular scenario may be determined by the actions of the visitor in a particular associated virtual environment. The selection of a particular scenario may also be affected by variables such as progress, or lack of progress, through various stages of a multi-stage virtual environment. In an embodiment, the virtual host interface senses a level of understanding of the visitor. The level of understanding is determined and the level of support adjusted to account for this.

Referring again to FIG. 4, according to an embodiment, virtual host interface 410 and virtual environment engine 420 may communicate with visitor's client device 320 via virtual environment content server 400 to provide an interactive shopping experience to the visitor. For example, virtual environment content server 400 may provide information to client device 320 for presentation to the visitor in an audible and/or visual format. Also, virtual environment content server 400 may receive information from client device 320, and communicate with virtual host interface 410.

According to an embodiment, virtual environment content server 400 may maintain and update information indicating product inquiry of a visitor. For example, virtual environment content server 400 may access and update a database (not shown) associating products with the visitor. Such information may comprise, for example, a last product inquiry associated in records with information uniquely identifying the visitor, such as a particular product installation.

According to an embodiment, virtual environment content server 400 may register a visitor by creating records associated with the visitor in a database comprising information gathered as part of a registration process. Such records may be used to collect and maintain information regarding the visitor such as, but not limited to, product installation specifications, geographic information for retail store location, and/or any other information that may be associated with individuals. This information that is gathered may be used to tailor a virtual environment experience to particular preferences or needs of a visitor.

In addition to communicating with virtual environment content server 400 over the Internet, client device 320 may comprise one or more output devices such as, for example, a speaker for providing an audio output and a high resolution display capable of displaying text, video images and/or still images. Here, such output devices may be used for presenting information rendered from media content received from the virtual host interface and/or virtual environment engine, for example. According to an embodiment, media content may be encoded in a particular format that enables a client device to render a presentation based, at least in part, on information encoded in such media content. Such device may be implemented in hardware, software, or combinations of hardware and software. Such a presentation may comprise, for example, images, text, sounds, other perceivable environmental phenomena and/or combinations thereof. In some embodiments, media content comprises information that may be used to render a presentation that is to be passively experienced by a viewer or listener. Alternatively, media content may comprise interactive media content which is responsive to inputs and/or stimuli from a visitor. Such interactive media content may be implemented in an interactive virtual environment to provide a visitor with an interactive virtual environment experience.

The software provided on a client device (e.g., personal computer, as shown in FIG. 3) for communicating with a virtual environment content server according to an embodiment includes display logic, input logic, and a network connectivity layer that comprise standard software and/or firmware that are associated with a client device. Virtual environment logic may comprise an agent application that is launched to the client device specifically for the purpose of interacting with the virtual environment content server to enable providing an interactive shopping experience to a visitor. In one embodiment, virtual environment logic may be downloaded from virtual host interface by selection of a universal resource locator (URL) as part of a process to register a visitor.

Referring about to FIG. 3, the software provided on virtual environment content server 310 may be illustrated as a single computing platform for the purpose of convenient illustration. It should be understood that virtual environment content server 310 may comprise multiple computing platforms integrated to provide functionality described herein. A communications layer may provide logic for communicating with a client device over a data communication network comprising, for example, Internet Protocol infrastructure. For example, communications layer may support UDP, TCP/IP, HTTP and/or higher layer protocols. The scripting layer may comprise context-specific rules and/or logic governing the scenarios, outcomes and processes to provide a context-specific shopping experience to the visitor. According to an embodiment, virtual environment content server may comprise “middleware” for integrating scripting layer with other applications provided on a client device.

While a scripting layer may comprise context-specific virtual environment logic, the virtual environment content server may be agnostic to any particular such context-specific virtual environment logic. Accordingly, client infrastructure may be preserved while a different or updated scripting layer may be integrated with virtual environment engine to give a visitor a new and/or updated interactive experience.

The virtual environment engine of the virtual environment content server may also communicate with a scenario database through a database layer storing information such as, for example, information associated with a visitor, such as personal profiles, visitor specific information such as, but not limited to, product installation. A scripting layer may access information in the database by invoking calls to the virtual environment engine. Such calls may comprise, for example, queries for specific information in the database retrievable through the virtual environment engine and the database layer.

The virtual environment content server may communicate with applications provided on a client device, such as personal computer shown in FIG. 3, through a network. In the particularly illustrated embodiment, the network may comprise Internet Protocol infrastructure capable of transmitting information between the server and client devices according to the Internet Protocol. As such, the virtual environment content server may communicate with the client device through the network.

A statistics layer may collect information regarding events of interest to be maintained in the database for evaluation and analysis. A database layer may be adapted to control access by the virtual host interface and/or statistics layer to the database.

The virtual environment logic provided on a client device may comprise a custom application compiled from source code developed in any one of several programming environments such as, for example, Java, C++, Adobe Flash, Adobe Flash Lite and/or the like.

While there has been illustrated and described what are presently considered to be example embodiments, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments disclosed, but that such claimed subject matter may also include all embodiments falling within the scope of the appended claims, and equivalents thereof.

What is claimed is:

1. A system comprising:
a computing platform adapted to communicate with a network, the computing platform being adapted to host a virtual environment engine and a virtual host interface, the virtual environment engine adapted to transmit an interactive scene on a display,
the virtual host interface comprising a plurality of video files stored on a storage medium, the virtual host interface being adapted to transmit a video representation of a human host overlaid on the interactive scene, the virtual host interface being adapted to visually simulate live interaction between a visitor and the virtual host based, at least in part, on at least one of the video files and in response to a query of the visitor,
the virtual host interface being adapted to compare a response to at least one predetermined response corresponding to at least one of the video files, and, if the response matches a predetermined response, transmit the at least one of the video files.

2. The system of claim 1, wherein the virtual host interface is further adapted to record a response of the visitor in an answer file, the computing platform being further adapted to process the answer file and access the virtual environment engine to transmit a corresponding virtual environment and access the virtual host interface to transmit a corresponding video file.

3. The system of claim 2, wherein each video file comprises an audio and video recording of a human actor presenting a scripted performance.

4. The system of claim 3, wherein the scripted performance comprises compositions selected from the list consisting of instructions, marketing, sales, and support.

5. A method comprising:
initiating display of a virtual environment including a predetermined scenario overlaid on a predetermined environment based on a visitor response;
analyzing response data representing the response;
determining response pattern data representing one or more of possible visitor responses based at least in part on the response data;
selecting query data representing query information adapted to persuade a visitor to select an object in the virtual environment;
processing the response pattern data and the query data so as to select a predetermined scenario in the form of video data overlaid on a predetermined environment that the visitor may be interested based at least in part on the response pattern data and the query data; and
initiating display of the predetermined scenario overlaid on the predetermined virtual environment.

6. The method of claim 5, further comprising:
soliciting a response from the visitor; and
initiating display of another predetermined scenario overlaid on another predetermined environment based at least in part on the response.

7. The method of claim 5, wherein said video data comprises a plurality of video files, each video file adapted to present a video representation of a human host performing a predetermined scripted presentation; and
wherein said virtual environment comprises a plurality of visitor interactive virtual environments enabling receiving visitor-selectable responses and generating response data based on the visitor-selectable response.

8. The method of claim 6, wherein the scripted presentations represent information related to one or more of product education, technical support, and sales.

9. The method of claim 8, wherein said plurality of visitor interactive virtual environments comprises visitor-selectable doors by which, if selected, another predetermined interactive environment with another predetermined scenario is transmitted.

10. The method of claim 9, further comprising:
transmitting one of a plurality of video files that are visitor-selectable based on a visitor response, the video files containing media based at least in part with one or more subject matter comprising product information, interviews with technology editors, analysis and discussions about technology trends and solutions, product installation, or product sales.

11. The method of claim 9, further comprising:
transmitting a shopping portal wherein the virtual environment includes a virtual store for the presentation of product and product related resources, and wherein the associated video files contain media with one or more subject matter related to product sales.

12. The method of claim 9, further comprising
transmitting a product support portal wherein the human host represents a technical support representative and wherein the associated video files contain media with one or more subject matter related to product technical support.

13. The method of claim 9, further comprising:
transmitting a library portal wherein the associated video files comprise media with one or more subject matter comprising, at least in part, product information, interviews with technology editors, analysis and discussions about technology trends and solutions, product installation, or product sales.

14. A computing platform comprising:
a virtual host interface including a plurality of video files representing various scenarios adapted for transmitting to and display on a display, the scenarios associated with predetermined responses expected from a visitor, the scenarios having a changeable order;
wherein the displaying of the video files is determined by:
a first set of rules governing whether one of the scenarios is to be presented to the visitor, and, if so, which of the scenarios is to be presented to the visitor, the first set of rules containing logical operators;
a second set of rules governing the respective orders of the scenarios, the second set of rules containing logical operators;
the virtual host interface being operable for:
processing the first set of rules according to the logical operators;
processing the second set of rules according to the logical operators;
receiving the responses from the visitor and determining whether the responses from the visitor are sufficient to prove a rule of the first set of rules;
selecting a closest rule from the first set of rules;
determining if the closest rule can be proven by responses from the visitor, and if so, presenting the visitor with a scenario associated with the closest rule, and if not, exempting the closest rule from the first set of rules and determining if a next closest rule can be selected from the first set of rules;
selecting one of a plurality of scenarios to present to the visitor;
receiving behavioral data about the visitor;
determining whether the behavioral data is sufficient to prove at least one rule of the second set of rules;
applying the second set of rules to determine the respective order of the scenarios;
initiating an action from a set of actions based at least in part on the determination; and
transmitting an interactive background environment underlay over which the scenarios are presented.

15. A computing platform of claim 14, where the scenarios comprise:
a plurality of learning scenarios relating at least in part to available products or interests of the visitor;
a plurality of shopping scenarios relating at least in part to the responses of a visitor; and
a plurality of product support scenarios relating at least in part to at least one product category.

16. A computing platform of claim 14, further comprising:
an alternative-offering mechanism for offering alternatives to the visitor, the alternative-offering mechanism operative to applying the second set of rules to determine the respective orders of the learning scenarios, the shopping scenarios, and the product support scenarios; and
a virtual environment engine operable to present to the visitor an interactive background environment underlay over which the scenarios are presented, the background environment operable with the scenario.

17. A computing platform, comprising:
a storage medium adapted for storing a plurality of pre-recorded audio-video presentations representative of a live action host assisting a visitor through one of a plurality of scenarios, the storage medium further adapted for storing a plurality of electronically generated graphic underlays representative of one of a plurality of environments; and
a microprocessor electronically associated with the storage medium operable to enable a visitor to select in sequence different ones of the plurality of scenarios according to a webpage thereon, the computing platform operable to superimpose the audio-video presentations onto the underlay to form a composite image, the computing platform operable via a web browser for enabling the composite image to be transmitted to and viewed on a display.

18. The computing platform of claim 17, the computing platform being operable to evaluate a level of support needed by a visitor so as to retrieve one of the plurality of video images so as to transmit appropriate interactive content.

19. The computing platform of claim 17, wherein the audio-video presentations comprise representations of a live action host assisting a visitor through one of a plurality of scenarios, the content of the scenarios being dependent on the selection made by the visitor.

20. The computing platform of claim 17, wherein the electronically generated graphic underlays comprise representations of one of a plurality of environments including a graphical representation of a room presenting a plurality of doors through which the host may enter based on a user response.

21. The computing platform of claim 17, wherein the plurality of scenarios comprises sales, support, and education scenarios.
